(19) United States
(12) Patent Application Publication
(10) Pub. No.: US 2013/0052293 A1
(43) Pub. Date: Feb. 28, 2013

(54) Fibrilation Apparatus

(71) Applicant: Oerlikon Textile GmbH & Co. KG, Remscheid (DE)

(72) Inventor: Jens Weinhold, Chemnitz (DE)

(73) Assignee: Oerlikon Textile GmbH & Co. KG, Remscheid (DE)

(21) Appl. No.: 13/663,629

(22) Filed: Oct. 30, 2012

Related U.S. Application Data
(63) Continuation-in-part of application No. PCT/EP2011/056929, filed on May 2, 2011.

(30) Foreign Application Priority Data
May 3, 2010 (DE) 102010019144.2
Aug. 5, 2010 (DE) 102010033546.0

(51) Int. Cl. B29C 53/26

(52) U.S. Cl. 425/336

(57) ABSTRACT

The present invention relates to apparatus for fibrillating ribbons or foils, wherein two or more strips each having a plurality of projecting fibrillating elements are disposed on the circumference of a fibrillating roll in a uniform distribution. To ensure gentle guidance of the ribbons and foils during fibrillation, the regions on the fibrillating roll between the circumferential strips each exhibit a friction-reducing surface contact.

This application is a continuation-in-part of and claims the benefit of priority from PCT application PCT/EP2011/056929 filed May 2, 2011; German Patent Application DE 10 2010 019 144.2 filed May 3, 2010; and German Patent Application DE 10 2010 033 546.0 filed Aug. 5, 2010, the disclosure of each is hereby incorporated by reference in its entirety.

The invention relates to an apparatus for fibrillating ribbons or foils according to the preamble of claim 1.

### BACKGROUND

Such devices for fibrillation of synthetic ribbons or synthetic foils, which have previously been extruded from a thermoplastic material, are generally known and are used to structure ribbons or foils. This allows, in particular, the form a structure extending in the longitudinal direction on otherwise smooth surfaces of strips or foils.

Fibrillation is typically conducted by a fibrillating roll as it is known for example from DE 1907 007 A1. On the periphery of the fibrillating roll are arranged a plurality of fibrillation elements, for example, in the form of projecting pins or needles so that during the guidance of the ribbons on the fibrillating roll, the pins pierce the ribbons and, depending on the wrapping of the ribbons around the fibrillating role, produce elongated tears in the ribbons. Thus, by the number and offset of such pins or needles on the periphery of the fibrillating roll, fibrillation structures can be so formed within a band.

In the known apparatus, the fibrillation elements are fastened to strips, which in a plurality are uniformly distributed on the periphery of the fibrillating roll. In this manner, surface areas are created on the periphery of the fibrillating roll between the strips, on which areas ribbons or foils can be conducted. It has now been found that, on the one hand, with increasing thickness of the ribbons, there occurs an undesired increase of the tensile forces in order to allow the penetration and tear of the ribbons. On the other hand, such preferred relative speeds between the fibrillating roll and the ribbons or the foil are set that one obtains a certain fibrillation pattern. Increasingly, particularly in the production of synthetic fiberglass ribbons made of several material components are formed that are sensitive to surface friction and are prone to damage.

### SUMMARY

It is therefore the technical task of the invention to provide a further developed device for fibrillating of the generic type so that the ribbons or the foil for fibrillation can be conducted around the fibrillating roll in larger wraps.

Another technical task of the invention is to provide a device for fibrillation of ribbons or a foil, by means of which fibrillation structures can be generated with even higher relative speeds.

This technical task is resolved by a device of the invention in that the fibrillating roll comprises a friction-reducing contact surface between the strips on the circumference.

Advantageous developments of the invention are defined by the features and combinations of features of the dependent claims.

The invention has the particular advantage that the fibrillating roll can be used with high flexibility to produce structures in ribbons and foils. Here, the ribbons and the foils can be particularly gently conducted on the contact surfaces of the fibrillating roll. In the manufacture of special fiberglass it has been found that very sticky and elastic materials are used that are very sensitive. In order to counteract the friction arising from the relative speed between the fibrillating roll and the ribbons, the ribbons can be advantageously conducted on the friction-reducing contact surfaces at the periphery of the fibrillating roll.

In order to ensure low friction values, on the one hand, and, on the other hand, to prevent premature wear of the fibrillating roll, the further development of the invention is particularly suitable, because the contact surfaces carry a multiple coating with a plurality of coating materials, which are formed from a plurality of sandwich-type single coatings.

To maintain the characteristics of the coating materials over very long periods, the further development of the invention is preferably specifically designed. Here, the individual coatings of the multi-layer coating each have a minimum thickness of >20 μm.

It is particularly advantageous if a single inner coating has a thickness greater by a factor of 5 than an outer single coating. This allows making coarser surface structures of the main body more uniform with a first single coating and thus protects them.

The preferred coating material of the outer coating is a low-friction material to reduce friction, and the coating material of the inner coating is formed by a single protective material to reduce wear.

Plastic materials, in particular PTFE, are preferably used as the low-friction material, and a ceramic material is preferably used as a protective material. This allows very high operation durability and provides a particularly gentle guiding on the fibrillating roll.

In the inventive device, the fibrillation elements are typically formed by needles in order to produce a fibrillation structure. However, in order to also fibrillate tear-sensitive and thicker ribbons or foils, cutting tips are advantageously used as fibrillation elements, whose blades are arranged as protruding elements.

For the production of reticulated fibrillation structures in ribbons, such development of the invention is particularly advantageous in which the adjacent blade rows on the circumference of the fibrillating roll are held on the respective strips offset to each other with their blades. The distribution of the partial incisions in the ribbons can be influenced both by the spacing of the blade strips on the circumference of the fibrillating roll and by the distance between the blade tips to each other.

According to another embodiment of the invention, the fibrillation roll comprises a controlled drive, which is connected to a machine control unit for setting a predetermined peripheral speed on the fibrillating roll. In the manufacture of such fibrillation structures, this allows directly using the predetermined process parameters, such as the draw ratio of the ribbons or foil, to set up a respective peripheral speed of the material roll specifically predetermined for the particular process and the particular material.

The device according to the invention is particularly suitable to fibrillate ribbons or foils of a relatively greater thickness and a relatively high material elongation after stretching them.

### BRIEF DESCRIPTION OF THE DRAWINGS

The device according to the invention will hereinafter be explained in detail by way of an embodiment example with reference to the accompanying figures. The content of the individual figures:

FIG. 1 shows a schematic diagram of a view of an embodiment of the inventive device in an extrusion process.

FIG. 2 shows a schematic cross-section of the embodiment of FIG. 1.

FIG. 3 shows a schematic plan view of the embodiment of FIG. 1.

FIG. 4 shows a schematic view of the fibrillating a roll.

FIG. 5 schematically shows a cross-sectional view of a contact surface of the fibrillating roll of FIG. 4.

FIG. 6 shows a schematic view of a pin of the fibrillating roll of FIG. 4.

### DETAILED DESCRIPTION

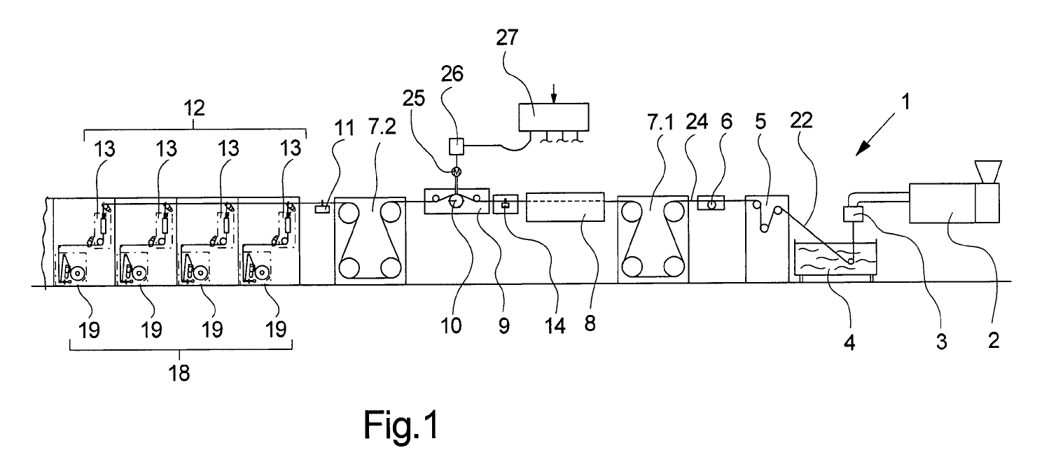

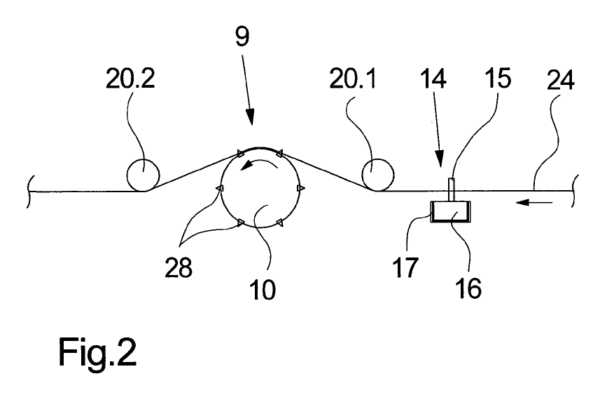

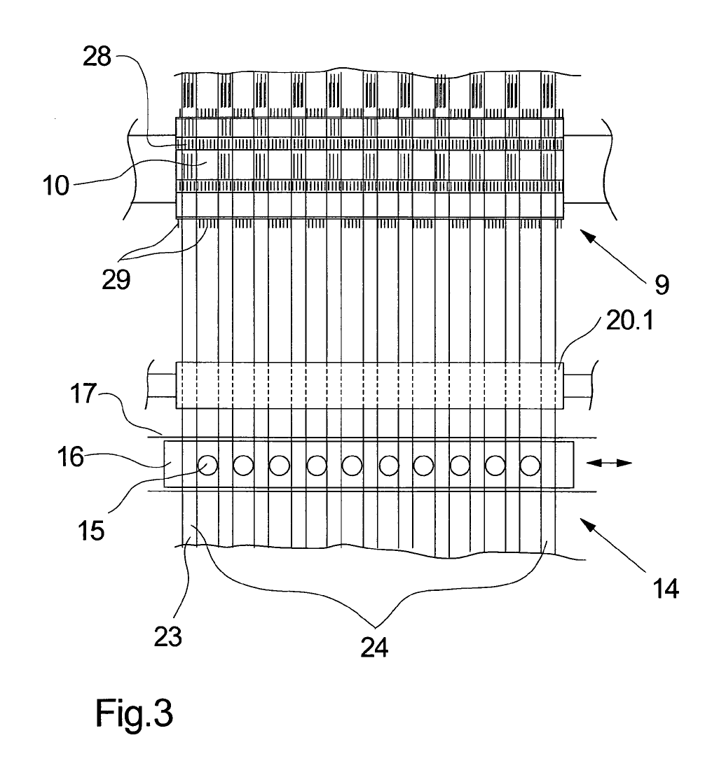

FIGS. 1 to 3 schematically illustrate an embodiment of the invention apparatus for fibrillating ribbons in an extrusion process. FIG. 1 shows the exemplary embodiment in an overall view of the extrusion process, FIG. 2 shows a side view and FIG. 3 shows schematically a plan view. The following description applies to all the figures, unless an explicit reference is made to one of the figures.

FIG. 1 shows the embodiment of the inventive apparatus in an overall view of an extrusion process. The exemplary embodiment has an extrusion device 1 for producing a foil from a thermoplastic material. In this example, the extrusion device 1 comprises an extruder 2. The extruder 2 is connected to an extrusion head 3, which extrudes a flat foil 22, made of thermoplastic material that has previously been molten by the extruder 2.

At this point it should be noted that the extrusion device 1 could also comprises to extrude, for example, a two-colored flat foil or a flat foil with different polymer materials.

The extrusion head 3 is associated with a cooling bath 4. On the outlet side of the cooling bath 4 is provided a re-direction mechanism 5 to remove from the foil 22 any residual liquid sticking to it by deflection and suction. For this purpose, the re-direction mechanism 5 is usually combined with a suction device, which drains off the adhering cooling liquid of the cooling bath 4.

A cutting device 6 is arranged downstream of the re-direction 5 to cut the foil 22 that has been produced in the extrusion device 1 into number of ribbons 24. In the cutting device 6, the foil 22 is cut into a plurality of individual ribbons 23 of a predetermined width.

For withdrawing the foil 22 or the ribbons 24 and stretching the ribbons, several godet feeding mechanisms 7.1 and 7.2 with driven godets are arranged after each other. The ribbons 23 are led with a simple wrap around the circumference of the driven godets of the godet feeding mechanisms 7.1 and 7.2 in parallel run side by side.

A heater 8 is arranged between the godet feeding mechanisms 7.1 and 7.2. The heating device 8 could be formed, for example, by a forced-air oven, in which the strips are heated up to a stretching temperature. In order to stretch the ribbons, the godets of the godet feeding mechanisms 7.1 and 7.2 are driven with a speed difference.

The fibrillation device designed according to the invention is arranged between the heater 8 and the second godet feeding mechanism 7.2 and is identified with reference numeral 9. The fibrillation device 9 has a fibrillating roll 10, on the periphery of which the ribbons are led with a partial wrap to be fibrillated. The fibrillating roll 10 is driven by an electric motor 25, which is controlled by the control unit 26. The control unit 26 is coupled to a machine control 27 so that it is possible to set a particular peripheral speed of the roll 10, depending on the production speed of the ribbons defined by the godet drives. Thus it is possible to drive the roll drive 10 with a circumferential speed that is preferably greater than the production speed of the ribbons 23.

To further explain the fibrillation device 9, additional reference is made to FIGS. 2 and 3. FIG. 2 shows a side view of the fibrillation device 9 and FIG. 3 shows a plan view of the fibrillation device 9.

The fibrillating roll 10 carries a plurality of strips 28 that are circumferentially equally spaced from each other, each having a plurality of protruding fibrillation elements 29. In this case, the fibrillation elements are formed by blade tips 30. Each blade tip 30 comprises a cutting edge 31, which is aligned in the direction of rotation of the fibrillating roll 10. This structure will be described in more detail below.

At this point, it should be explicitly noted that the fibrillating elements 29 on the fibrillation roll 10 can alternatively be formed by protruding needles, which are held on the strips 28.

On the inlet side of the ribbons 24, the fibrillating roll 10 is associated with an adjusting device 14. The adjusting device 14 comprises a plurality of essentially vertically aligned guide pins 15, which are held on a carrier 16. The guide pins 15, which could alternatively be formed by freely rotatable guide rollers on vertical axes, each extend between two adjacent ribbons 23 of the group of ribbons 24. The guide pins 15 are dimensioned in their outer diameter such that the ribbons 23 are guided essentially without clearance between two adjacent pins 15. The carrier 16 that carries the guide pins 15 is held in a guide rail 17 and can be shifted within the guide rail 17 transversely to the running direction of the ribbons 23. By shifting the carrier 16, the ribbons 23 of the group of 24 can be adjusted relative to the position of the blade tips 30 on the periphery 30 of the fibrillating roll 10. In particular, this therefore allows symmetrical cuts to be made by the blade tips 30 in the ribbons 23. In particular, this allows minimum distances at the edge areas in the ribbons to be achieved.

In order to obtain a defined wrap of the group of ribbons around the periphery of the fibrillating roll 10, two guide rollers 20.1 and 20.2 are provided, which lead the inlet and the outlet of the group of ribbons 24.

After fibrillation and stretching, the ribbons 23 are fed to a crimping device 12 and a wind-up device 18. The crimping device 12 and the wind-up device 18 comprise several texturizer means 13 and wind-up stations 19 to texture and wind up the ribbons individually or in groups. For this purpose, using a guide device 11 the ribbons 24 can be isolated or led together in groups.

In the extrusion process shown in the example in FIG. 1, a grass yarn is produced, which in a finishing process could already be processed directly into an artificial turf. The fibrillation device 9 used there can in principle be also used in other extrusion processes, in which for example a foil must be fibrillated.

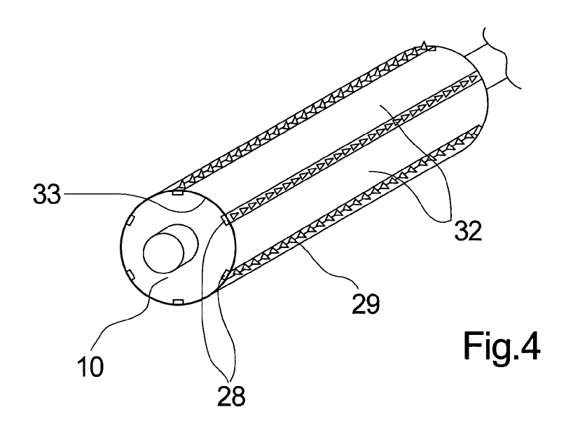

To allow as gentle as possible a guidance of the ribbons on the periphery of the fibrillating roll 10, friction-reducing contact surfaces 32 are formed on the periphery between the strips 28. For clarification, FIG. 4 shows the fibrillating roll 10 of the aforementioned exemplary embodiment in a perspective view. The fibrillating roll 10 comprises several strips 28, which are uniformly arranged on the periphery of the fibrillating roll 10. Between the strips 28 on the circumference of the fibrillating roll 10 are arranged several friction-reducing contact surfaces 32. The contact surfaces 32 of the fibrillating roll 10 that extend between the strips 28 have a multi-layer coating 33. In order to enable an optimum low-friction and stable guidance of the ribbons on the contact surfaces 32, the multi-layer coating 33 is preferably formed from a plurality of individual layers, which are arranged one above the other like a sandwich.

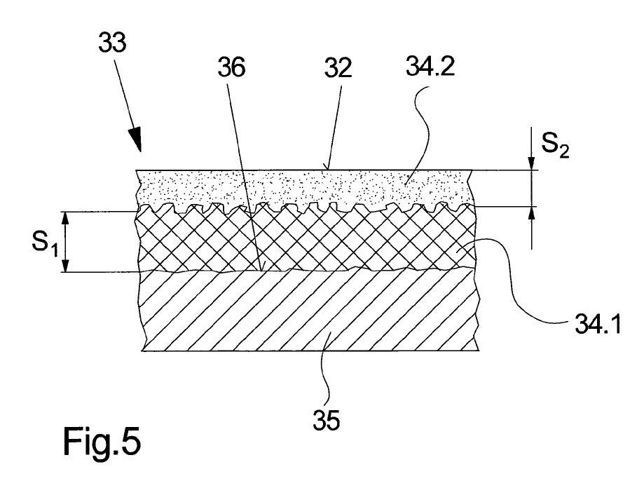

FIG. 5 shows a schematically cross-sectional view of a typical multiple-layer coating 33. The multi-layer coating 33 in this embodiment is formed by an inner single coating 34.1 and an outer single coating 34.2, which are superposed like a sandwich. Here, the inner individual coating 34.1 is applied directly on the coating surface 36 of the shell 35 of the fibrillating roll 10. The inner single coating 34.1 is applied with a layer thickness S1. Above the inner single coating 34.1 is applied an outer single coating 34.2 with a thickness S2. The outer single coating 34.2 has a low-friction material as a coating material so that contact surface 32 directly facing the ribbons is determined by the material properties of the low-friction material. In contrast, the coating material of the inner single coating 34.1 is formed by a protective material, which represents a wear-resistant layer over the shell 35 of the fibrillating roll 10. A ceramic material is preferably used as a protective material, which is applied directly onto the coating surface 36 of the shell 35. Such ceramic materials can be applied, for example, as a plasma coating. In this embodiment, the interfacial surface of the inner individual coating 34.1 to the outer single coating 34.2 is roughly structured so that in the operating state after the low-friction coating in the outer coating 34.2 wears off, there is a mixed surface, which is formed by surface portions of the low-friction material and surface portions of the protective material. Such a guide surface has the particular advantage that the ribbons or the foil can be led with low friction and in a wear-resistant fashion. The low-friction material is commonly formed from plastics, where in particular PTFE materials (Teflon) turned out to be particularly advantageous for the guidance of ribbons.

In one embodiment of the fibrillation roll 35, the shell may initially be applied with a plasma coating with a ceramic material in a layer thickness S1 of about 0.3 mm. Then a PTFE coating of a layer thickness S2 of about 0.04 mm may be applied in a sandwich-like manner over the ceramic layer. There has been found that a particularly advantageous ratio of the layer thicknesses in the combination of an outer low-friction coating and an inner protective material is when the thickness of the inner individual coating 34.1 is greater by factor of 5 than the outer single coating 34.2 (S1>5×S2).

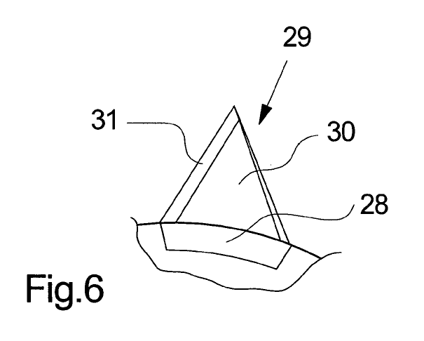

As further shown in the illustration in FIG. 4, the strips 28 carry has a plurality of blade tips 30 that are held as a set of blades protruding from the bar 28 with a certain distance from each other. Each of the blade tips 30 comprises a cutting edge 31, which is aligned in the circumferential direction of the running fibrillating roll 10. As an example, FIG. 6 shows a view of the blade tip 30. The blade tips 30 are held on the blade strip 28, wherein the strip 28 is arranged in a groove of the fibrillating roll 10. The blade tip 30 is of a triangular design with a protruding peak. On one side of the blade tip 30, the cutting edge 31 is ground, which extends up to the tip. The blade 31 is oriented in the direction of circulation of the fibrillating roll 10 so that during the rotation of the fibrillating roll a finite partial incision is produced depending on the wrapping of the ribbon.

The arrangement of the blade tips 30 and the strips 28 can be selected such that different fibrillation patterns arise. Thus, for example, parallel arrangements of blade tips and offset arrangement of blade tips are both possible.

For the fibrillation, the fibrillating roll 10 is preferably operated at a peripheral speed, which is 20% to 60% faster than a withdrawal speed of the ribbons. Due to the low cutting resistance of the blade tips 30 during the fibrillation, relatively small differences in speed between the ribbons and the fibrillating role can be maintained. The small incision resistance during the fibrillation is also particularly suitable for providing very elastic ribbons and very thick ribbons with a uniform fibrillation structure.

Thus, the inventive device is useful, in particular, in the production of grass yarns. Due to the very good low-friction properties of the contact surfaces 32 on the circumference of the fibrillating roll 10, even elastic and sticky materials could be fibrillated with relative speeds. Ribbons, which are preferably produced by co-extrusion and have a thicknesses ranging from 150 to 500 μm, can be advantageously fibrillated. The expansions of the ribbons can have values of above 50%. Thus, elastic ribbons with an elongation of up to 75% can be securely fibrillated.

The device according to the invention is basically suitable to fibrillate all conventional ribbons and foils made of thermoplastic materials. There is also the possibility that in the embodiment shown in FIG. 1, the extrusion head 3 is replaced by a monofilament extrusion tool so that directly during the extrusion a plurality of individual ribbons can be produced. In this case, the cutting device shown in FIG. 1 is omitted. In that regard, the apparatus according to the invention is also particularly suited after stretching to fibrillate singly generated ribbons. Here, in particular high densities of partial cuts in the individual ribbons are possible. By proper adjusting, even small minimum distances on the edge of the ribbons can be set up and safely maintained. The PP, LLDPE, HDPE, or PA types of polymer have proven to be most suitable for this purpose.

### REFERENCE NUMBERS LIST

1 Extrusion device
2 Extruder
3 Extrusion head
4 Cooling bath
5 Re-direction mechanism
6 Cutting device
7 Godet mechanism
8 Heater
9 Fibrillation device
10 Fibrillating roll
11 Guide device
12 Crimping device
13 Texturizer
14 Adjusting device
15 Guide pin
16 Carrier
17 Guide rail
18 Wind-up device
19 Wind-up station
20 Guide roller
21 Guide groove
22 Foil
23 Single ribbon
24 Group of ribbons
25 Electric motor
26 Control unit
27 Machine control
28 Cutting blade
29 Fibrillation element
30 Blade tip
31 Cutting edge
32 Contact surface
33 Multiple coatings
34.1, 34.2 Single coating
35 Shell
36 Coating surface

1. An apparatus for the fibrillation of ribbons or foils with a fibrillating roll that comprises a plurality strips uniformly arranged on the circumference, on to which a plurality of protruding fibrillation elements extend radially outward; and, a friction reducing contact surface disposed between the strips.

2. The apparatus according to claim 1, wherein the contact surfaces include a multilayer coating with several coating materials formed from sandwich-like individual coatings.

3. The apparatus according to claim 2, wherein the sandwich-like individual coatings each have a minimum layer thickness of >20 μm.

4. The apparatus according to claim 3, wherein the sandwich-like individual coatings include an inner single coating having a thickness greater by a factor of 5 than a thickness of an outer single coating.

5. The device according to claim 1, wherein a coating material of the outer single coating is formed from a low-friction material to reduce friction and a coating material of the inner single coating is formed from a protective material to reduce wear.

6. The apparatus according to claim 5, wherein the protective material is formed from a ceramic material and the low-friction material is formed from a plastic material.

7. The apparatus according to claim 6 wherein the low-friction material is a PTFE.

8. The device according to claim 1, wherein the fibrillation elements comprise a needle shape or blade tip having a cutting edge disposed in a protruding arrangement.

9. The apparatus according to claim 8, wherein the blade tip is offset from each other, on adjacent strips on the circumference of the fibrillating roll.

10. The device that according to claim 1 further comprising a controllable drive connected to an engine control unit for setting a predetermined peripheral speed on the fibrillating roll.
